(19) United States
(12) Patent Application Publication
(10) Pub. No.: US 2002/0060998 A1
(43) Pub. Date: May 23, 2002

(54) CDMA search processing load reduction

(76) Inventor: Jason F. Hunzinger, Carlsbad, CA (US)

Correspondence Address: SCOTT C. HARRIS, Fish & Richardson P.C., Suite 500, 4350 La Jolla Village Drive, San Diego, CA, 92122, US

(21) Appl. No.: 09/998,845

(22) Filed: Nov. 15, 2001

Related U.S. Application Data
(60) Provisional application No. 60/252,969, filed on Nov. 22, 2000.

(51) Int. Cl. H04B 7/216

(52) U.S. Cl. 370/335; 370/342

(57) ABSTRACT

A search-processing load for a wireless device is adjusted to reduce processor loading. A reference sector search frequency is measured and compared to a predetermined limit. If the reference sector search frequency exceeds the predetermined limit, then the search-processing load is reduced.

### CROSS REFERENCE TO RELATED APPLICATIONS

This application claims the benefit of U.S. Provisional Application No. 60/252,969, filed Nov. 22, 2000, the entire disclosure of which is incorporated herein by reference.

### TECHNICAL FIELD

This invention relates to wireless communications devices, and more particularly to search processing load reduction methods for wireless communications based on CDMA.

### BACKGROUND

Cellular telephones may operate under a variety of standards including the code division multiple access (CDMA) cellular telephone communication system as described in TIA/EIA, http://164.195.100.11/netacgi/nph-Parser?Sect1=PTO2&Sect2=HITOFF&p=1&u=/netahtml/-h22http://164.195.100.11/netacgi/nph-Parser?Sect1=PTO2&Sect2=HITOFF&p=1&u=/netahtml/-h24IS-95, Mobile station-Base Station Compatibility Standard for Dual-Mode Wideband Spread Spectrum Cellular System, published July 1993. CDMA is a technique for spread-spectrum multiple-access digital communications that creates channels through the use of unique code sequences. In CDMA systems, signals can be and are received in the presence of high levels of interference. The practical limit of signal reception depends on the channel conditions, but CDMA reception in the system described in the aforementioned http://164.195.100.11/netacgi/nph-Parser?Sect1=PTO2&Sect2=HITOFF&p=1&u=/netahtml/-h23http://164.195.100.11/netacgi/nph-Parser?Sect1=PTO2&Sect2=HITOFF&p=1&u=/netahtml/-h25IS-95 Standard can take place in the presence of interference that is 18 dB larger than the signal for a static channel. Typically, the system operates with a lower level of interference and dynamic channel conditions.

A mobile station using the CDMA standard constantly searches a Pilot Channel of neighboring base stations for a pilot that is sufficiently stronger than a pilot add threshold value T_ADD. As the mobile station moves from the region covered by one base station to another, the mobile station promotes certain pilots from the Neighbor Set to the Candidate Set, and notifies the base station or base stations of the promotion from the Neighbor Set to the Candidate Set via a Pilot Strength Measurement Message. The base station determines an Active Set according to the Pilot Strength Measurement Message, and notifies the mobile station of the new Active Set via a Handoff Direction Message. The mobile station will maintain communication with both the old base station and the new base station so long as the pilots for each base station are stronger than a pilot drop threshold value T_DROP. When one of the pilots weakens to less than a pilot drop threshold value, the mobile station notifies the base station of the change. The base station may then determine a new Active Set, and notifies the mobile station of that new Active Set. Upon notification by the base station, the mobile station then demotes the weakened pilot to the Neighbor Set.

Constant pilot searching and the associated computer processing can be extremely demanding to perform on a real-time basis. Increased cost of manufacture places a restriction on the processing power available in a mobile station. However, restricting or slowing down the pilot searching can have a negative impact on connection origination, connection termination and dropped call performance. It is desired to minimize the processing load associated with pilot searching while maintaining mobile station call performance so that the processor can be used for other applications.

### SUMMARY

A method of regulating pilot search processing load while maintaining mobile station call performance is provided. The method reduces search-processing load while assuring that the most critical pilots are searched at a level sufficient to maintain call performance. The search frequency of the most critical pilot is measured and compared to predetermined threshold levels. If load reduction is necessary, the search parameters are adjusted to lower the overall search-processing load while maintaining an adequate level of searching for the most critical pilots.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is an illustration of a wireless communication system.

FIG. 2 is an illustration of a portion of a wireless communication system.

FIG. 3 shows a block diagram of a processor system in a CDMA mobile station.

FIG. 4 is an illustration of a search-processing load reduction method in accordance with the principles of the invention.

### DETAILED DESCRIPTION

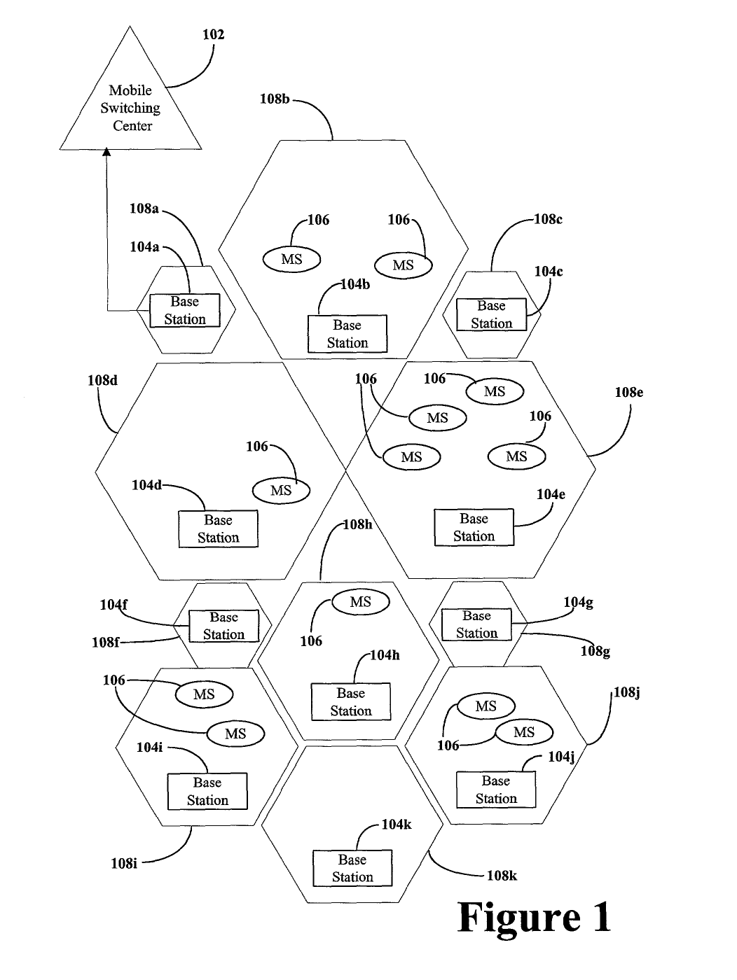

FIG. 1 illustrates components of an exemplary wireless communication system. A mobile switching center 102 communicates with base stations 104a-104k (only one connection shown). The base stations 104a-104k (generally 104) transmits data to and receives data from mobile stations 106 within cells 108a-108k (generally 108). A cell 108, corresponding to a geographic region, is served by a base station. Practically, said geographic regions often overlap to a limited extent.

A mobile station 106 is capable of receiving data from and transmitting data to a base station 104. In one embodiment, the mobile station 106 receives and transmits data according to a Code Division Multiple Access (CDMA) technique. CDMA is a communication technique that permits mobile users of wireless communication devices to exchange data over a telephone system, wherein radio signals carry data to and from the wireless devices. A set of standards that define a version of CDMA that is particularly suitable for use with the invention include IS95, IS-95A, and IS-95B, Mobile Station-Base Station Compatibility Standard for Dual-Mode Spread Spectrum Systems; TIA/EIA/IS-2000-2, Physical Layer Standard for cdma2000 Spread Spectrum Systems; and TIA/EIA/IS-2000-5 Upper Layer (Layer 3) Signaling Standard for cdma2000 Spread Spectrum Systems, all of which are herein incorporated by reference in their entirety.

Under the CDMA standard, additional cells 108a, 108c, 108d, and 108e adjacent to the cell 108b permit mobile stations 106 to cross cell boundaries without interrupting communications. This is so because base stations 104a, 104c, 104d, and 104e in adjacent cells assume the task of transmitting and receiving data for the mobile stations 106. The mobile switching center 102 coordinates all communication to and from mobile stations 106 in a multi-cell region. Thus, the mobile switching center 102 may communicate with many base stations 104.

Mobile stations 106 may move about freely within the cell 108 while communicating either voice or data. Mobile stations 106 not in active communication with other telephone system users may, nevertheless, continue to search for pilot channel transmissions from the base stations 104 in the cells 108 to detect pilots that are sufficiently strong with which to establish a communications link. In addition, mobile stations 106 may drop base stations 104 in which the energy level of the pilot is not sufficiently strong.

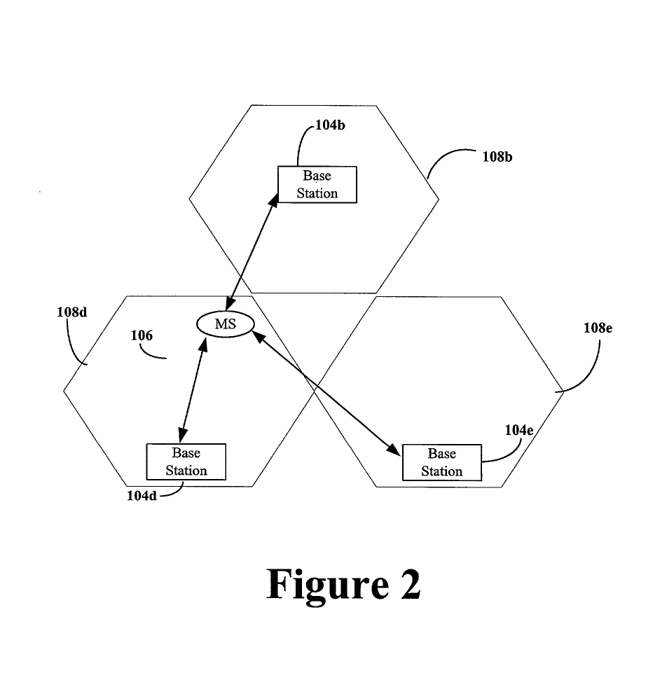

One example of such a mobile station 106 is a cellular telephone used by a vehicle driver who converses on the cellular telephone while driving in a cell 108b. Referring to FIG. 2, a portion of a wireless system is shown. The cellular telephone synchronizes communication with the base station 104b by monitoring a pilot that is generated by the base station 104b. While powered on, the mobile station 106 continues to search predetermined CDMA system frequencies for pilots from other base stations 104 such as the pilots from the base stations 104d and 104e as well as the pilot corresponding to the base station 104b. Upon detecting a pilot from another base station 104d, the mobile station 106 initiates a handoff sequence to add the pilot to the Active Set. Likewise, upon determining that the energy level of an Active Set pilot has weakened sufficiently and the handoff timeout value, T_TDROP, has been exceeded, the mobile station 106 initiates a handoff sequence to drop the pilot.

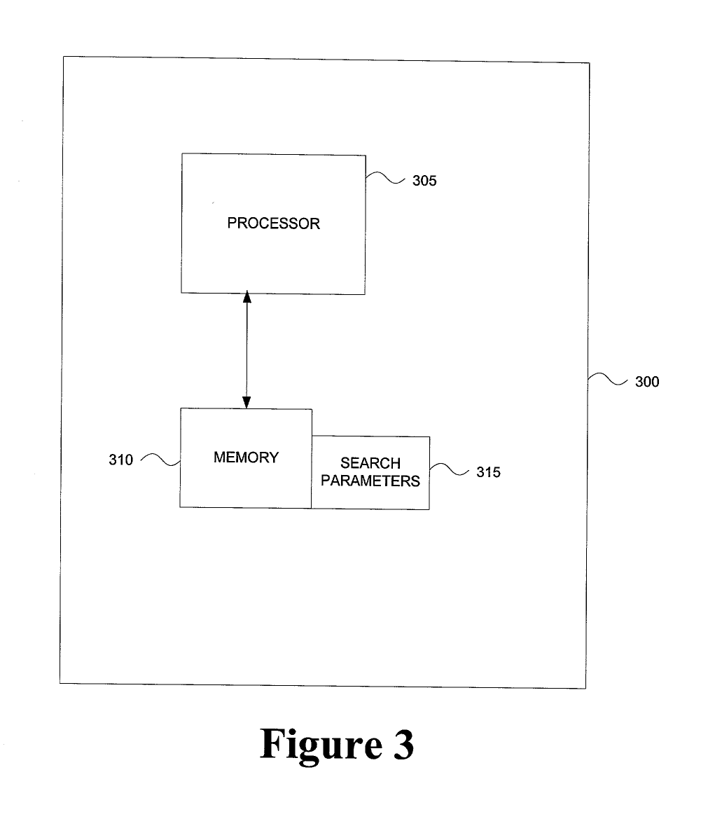

FIG. 3 shows a block diagram of CDMA telephone 300 and the processing that occurs in that telephone. The processor 305 is driven by a program stored in memory 310. Parameters for the telephone may also be stored in another part of memory shown here as 315. The memory 315 stores various parameters that affect the pilot search process. These parameters will be discussed in more detail later.

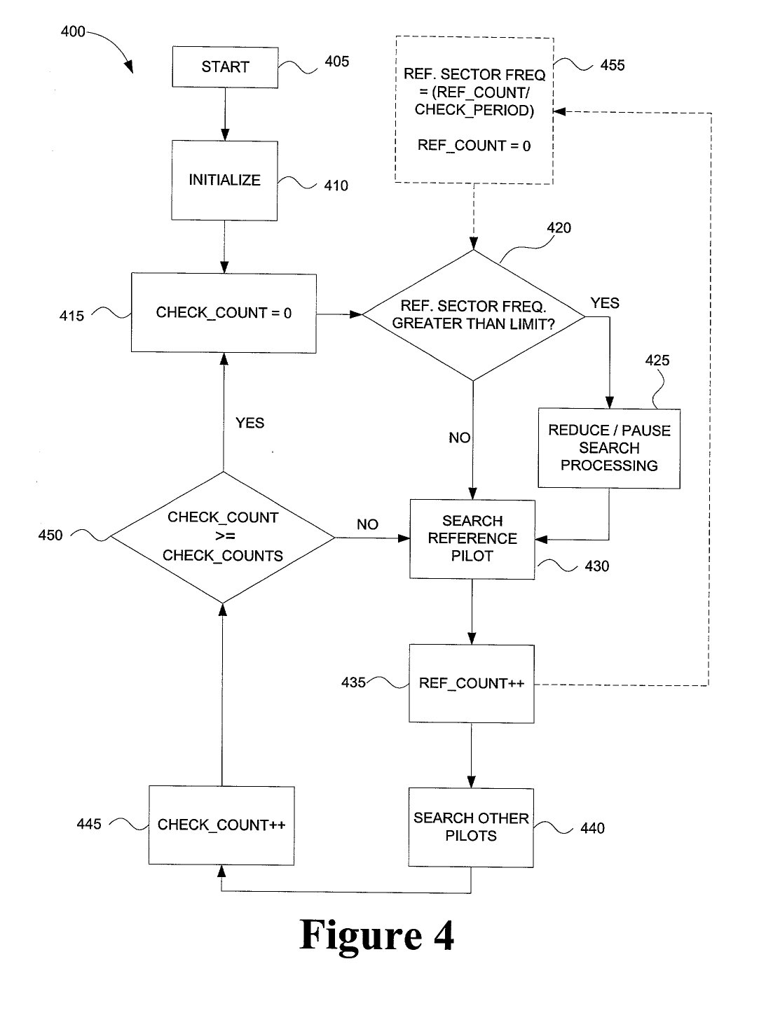

The processor 300 executes a program 400 shown in FIG. 4. The program begins at start block 405. Proceeding to block 410 the program initializes the variables such as setting REF_COUNT, a count of the reference sector searches in a current period, to zero and initializing search parameters to default values. The search parameters may include those parameters that affect the search-processing load of the processor 300. Proceeding to block 415, the CHECK_COUNT variable, a count of the number of search checks in a current period, is set to zero. This counter is used to limit the frequency at which the load reduction operation is performed.

Block 420 compares a measured Reference Sector search Frequency (REF. SECTOR FREQ. in 420) to a predetermined limit. If the REF. SECTOR FREQ. is greater than a predetermined limit, then the program proceeds to block 425 where a method of reducing the search processing load is performed. Methods of reducing the search processing load and methods of setting the predetermined limit will be discussed later. If the REF. SECTOR FREQ. is not greater than the predetermined limit, then the program proceeds to block 430 where the Reference Pilot is searched. The Reference Sector search frequency may be determined by dividing the reference count REF_COUNT by the check period or CHECK_COUNT.

The reference sector pilot is typically the pilot whose demodulated signal is the earliest received signal with respect to CDMA system time. The reference sector pilot could alternatively be selected as the strongest received pilot or the most reliable pilot (e.g. lowest frame error rate, etc.). CDMA call performance is directly dependent on the ability of the mobile station to monitor and maintain Active Set Pilots and locate replacements to include in the Candidate Set from the Neighbor Set and Remaining Set Pilots. The ability of the mobile station to efficiently search the most critical pilots most frequently is crucial to performance. The invention enables a mobile station to search the pilots from the Active Set, Candidate Set, and the most advantageous Neighbor Set and Remaining Set pilots in an efficient manner up to the highest processing level allowed by the processor 305.

After searching the reference sector pilot in block 430, the program increments the REF_COUNT counter by one. The REF_COUNT is used by the program to calculate the REF. SECTOR FREQ. in block 455. The block 455 computation is done periodically (over a period of time equal to CHECK_PERIOD in the embodiment shown in FIG. 4) and asynchronously to the load reduction process (as signified by being represented by dashed lines in FIG. 4). The REF. SECTOR FREQ. computation is then used in the comparison to the predetermined limit of block 420 that was discussed previously. When the REF. SECTOR computation is completed, the REF_COUNT variable is reset to zero in block 455.

After incrementing the REF_COUNT counter in block 435, the program proceeds to block 440 where the other pilots besides the reference sector pilot are searched. The searching methodology utilized in block 440 is not critical to the ability of the invention to limit the search-processing load. However, the searching methodology is important with respect to performance of the mobile station. The reference sector pilot is usually the most frequently searched and the most performance critical pilot because it is the main Active Set pilot used for demodulation or system timing. The search sequencing of the other pilots in block 440 is generally relative to the search frequency of the reference sector pilot. For example, block 440 may allow all Active and Candidate Set pilots be searched and up to 2 Neighbor Set pilots and 1 Remaining Set pilot be searched for each search of the reference sector pilot. A different subset of Neighbor Set and Remaining Set pilots may be searched on each pass. The search sequencing parameters, as well as the predetermined threshold limit used in block 420, are best determined through experimentation. The experimentation may involve varying system parameters including but not limited to window size and the frequency of searching other pilots relative to each search of the reference sector pilot. The system parameters are determined to allow enough reference sector searches to provide good performance while not depriving other processor tasks from being completed. Window size is the size of the time window (usually in chips) that is searched for signals. For example, if the window size is N, then correlations are attempted at −N/2 through +N/2 from the reference time. In other words, correlations are attempted up to N/2 earlier than the reference time and N/2 later than the reference time. A smaller window size will require a lower search-processing load.

After searching the other pilots in block 440, the program proceeds to block 445 where the CHECK_COUNT counter is incremented. Proceeding to block 450, the CHECK_COUNT counter is checked against a predetermined minimum number of searches, CHECK_COUNTS. If CHECK_COUNT exceeds or equals CHECK_COUNTS, then the program proceeds to block 415 where CHECK_COUNT is reset to zero and then proceeds to the REF. SECTOR CHECK 420. If CHECK_COUNT does not exceed or equal CHECK_COUNTS, the program proceeds to block 430 again where the reference sector pilot is searched. This limits the number of times the search processing load is checked to no more than once every CHECK_COUNTS searches of the reference sector pilot. The value of CHECK_COUNTS could be an experimentally determined static value or adaptive value. Many well known adaptive algorithms could be used to adapt CHECK_COUNTS to achieve the desired frequency of load reduction checks.

Discussion will now return to Block 425 where the actual search-processing load reduction is performed. This load reduction can take on several embodiments, all of which are in the scope of the invention. A first embodiment is a simple pause in time. The pause in time value could be adaptive or static. When the program pauses at block 425, all other processes will be performed by the processor 305. It is only when the pause time is exceeded that pilot searches 430 and 440 will be permitted. Though not shown in FIG. 4, another embodiment would involve an adaptive pause time computation be performed if block 420 did not result in an exceeded threshold. This would have the effect of decreasing the pause time to be used in block 425 when block 430 shows a lower REF. SECTOR FREQ. and increasing pause time for a high REF. SECTOR FREQ.

Another embodiment for block 425 would involve changing the previously mentioned search parameters that affect the searching of other pilots relative to the sector pilot in block 440. By reducing the relative search frequencies of the other pilots in the Active, Candidate, Neighbor or Remaining Sets, one can reduce the search processing load. As with the pause time embodiment, there could also be a load increasing adaptation performed when block 420 shows that a lower than desired REF. SEARCH FREQ. is present. Another embodiment would be to increase or decrease search window sizes or search correlation length to achieve the appropriate timing of searches and, in turn, processor loading.

A number of embodiments of the invention have been described. Nevertheless, it will be understood that various modifications may be made without departing from the spirit and scope of the invention. Accordingly, other embodiments are within the scope of the following claims.

What is claimed is:

1. A method of adjusting a search-processing load for a wireless device, comprising:
measuring the frequency in which a reference sector is searched;
determining if the frequency in which a reference sector is searched is greater than a predetermined limit; and
reducing the search processing load when the frequency in which a reference sector is searched is greater than the predetermined limit.

2. The method of claim 1, further comprising pausing processing associated with pilot searches for a predetermined time period to reduce the search processing load.

3. The method of claim 1, further comprising adjusting a set of search parameters to lower the search-processing load.

4. The method of claim 1, further comprising searching one of a plurality of subsets of secondary sectors each time the reference sector is searched.

5. The method of claim 4, further comprising selecting a different one of the plurality of subsets of secondary sectors with each reference sector search.

6. The method of claim 1, further comprising increasing the search processing load when the frequency in which a reference sector is searched is below than the predetermined limit.

7. The method of claim 1, further comprising selecting a reference sector.

8. The method of claim 7, wherein the reference sector is selected from a group consisting of the earliest received signal, the strongest received signal, and the most reliable signal.

9. The method of claim 1, further comprising adjusting the predetermined limit based on historical information.

10. The method of claim 1, further comprising reselecting the reference sector following a handoff.

11. A mobile station for use in a wireless communication system comprising a processor which determines how often a reference sector is being searched and compares how often the reference sector is searched to a threshold value, wherein the processor reduces how often the reference sector is searched when the reference sector is searched more than the threshold value.

12. The mobile station of claim 11, wherein the processor reduces how often the reference sector is searched by pausing processing associated with pilot searches for a predetermined time period.

13. The mobile station of claim 11, wherein the processor reduces how often the reference sector is searched by adjusting a set of search parameters.

14. The mobile station of claim 11, wherein the mobile station searches one of a plurality of subsets of secondary sectors each time the reference sector is searched.

15. The mobile station of claim 14, wherein the mobile station selects a different one of the plurality of subsets of secondary sectors with each reference sector search.

16. The mobile station of claim 11, wherein the processor increases how often the reference sector is searched when the reference sector is searched less than the threshold value.

17. The mobile station of claim 11, wherein the processor selects a reference sector.

18. The mobile station of claim 17, wherein the reference sector is selected from a group consisting of the earliest received signal, the strongest received signal, and the most reliable signal.

19. The mobile station of claim 11, wherein the processor adjusts the threshold value based on historical information.

20. The mobile station of claim 11, wherein the mobile station reselects the reference sector following a handoff.
